(19) United States
(12) Patent Application Publication
(10) Pub. No.: US 2026/0316748 A1
(43) Pub. Date: Oct. 15, 2026

(54) SAFETY SYSTEM FOR A VEHICLE

(71) Applicants: Toyota Research Institute, Inc., Los Altos, CA (US); The Trustees of Princeton University, Princeton, NJ (US)

(72) Inventors: Donggeon David Oh, Princeton, NJ (US); Justin Lidard, Reston, VA (US); Haimin Hu, Plainsboro, NJ (US); Jaime Fernández Fisac, Princeton, NJ (US); Naomi Ehrich Leonard, Princeton, NJ (US); Duy Nguyen, Philadelphia, PA (US); Jonathan A. DeCastro, Arlington, MA (US); Guy Rosman, Newton, MA (US)

(73) Assignees: Toyota Research Institute, Inc., Los Altos, CA (US); Toyota Jidosha Kabushiki Kaisha, Toyota-Shi Aichi-Ken (JP); The Trustees of Princeton University, Princeton, NJ (US)

(21) Appl. No.: 19/641,805

(22) Filed: Apr. 8, 2026

Related U.S. Application Data
(60) Provisional application No. 63/785,737, filed on Apr. 9, 2025.

(51) Int. Cl. B60W 30/08; B60W 50/08

(52) U.S. Cl. CPC B60W 30/08; B60W 50/087

(57) ABSTRACT

Embodiments described herein relate to safety systems for vehicles. In one implementation, a method includes receiving, from an operator of a vehicle, an input intended to control the vehicle. The method also includes evaluating a safety of the input using a state-action function that quantifies the safety of the input based on a current state of the vehicle. The method also includes optimizing, based on the safety, a vehicle action that modifies the input by minimizing a deviation between the input and the vehicle action. The method further includes executing, based on the safety, the vehicle action to control the vehicle, thereby maintaining safety while maximally preserving human agency.

### CROSS-REFERENCE TO RELATED APPLICATION

This application claims benefit of U.S. Provisional Application No. 63/785,737, filed on Apr. 9, 2025, which is herein incorporated by reference in its entirety.

### TECHNICAL FIELD

The subject matter described herein relates, in general, to safety systems for vehicles and, more particularly, to a safety system for a vehicle that maximally preserves human agency over the vehicle.

### BACKGROUND

Many vehicles include driver assistance systems that are capable of intervening in emergency situations. For example, some vehicles equipped with driver assistance systems include automatic braking that stops the vehicle when the driver assistance system detects an imminent collision. In another example, some vehicles include lane keeping that automatically steers the vehicle when the driver assistance system detects that the vehicle is leaving the lane in which the vehicle is traveling. However, most driver assistance systems typically deliver abrupt, last-moment corrections that can take a driver by surprise. Known as “automation surprise,” this characteristic of driver assistance systems can cause drivers to be startled by vehicle interventions or can cause drivers to attempt to overtake the intervention, leading to dangerous driving scenarios and uncomfortable driving experiences.

### SUMMARY

The embodiments described herein are directed to a safety system for a human-operated vehicle that gradually intervenes to ensure safe operation of the vehicle while maximally preserving the agency of the operator. As noted above, in some instances, automation surprise can lead to dangerous driving scenarios and uncomfortable driving experiences. In one approach, the safety system receives, from the operator, an input intended to control the vehicle. The input, in one implementation, is a position and/or movement of a steering wheel of the vehicle and/or an operation of a brake pedal or accelerator pedal of the vehicle. In one approach, the safety system evaluates a safety of the input using a state-action safety value function that quantifies the safety of the input based on the current state of the vehicle. The current state of the vehicle, in one approach, includes the position of the vehicle with respect to an external environment of the vehicle, characteristics about the movement of the vehicle such as speed, acceleration, etc., contact between the wheels of the vehicle and the road on which the vehicle is traveling, etc. In one implementation, if the safety system determines that the safety of the input satisfies a safety constraint, the safety system will execute the input to operate the vehicle according to the intent of the operator.

However, if the safety system determines that the safety of the input does not satisfy the safety constraint, the safety system will, in one embodiment, optimize and execute a vehicle action that modifies the input to maintain safe operation of the vehicle while preserving the intent of the operator. In one approach, the vehicle action is a modification of the input of the operator that minimizes a deviation between the input and the vehicle action. In any case, the safety constraint is, in one embodiment, a model-free discrete-time control barrier function that ensures that the state-action safety value function of the vehicle action is greater than or equal to a threshold value derived from a current state safety value function. As a result, the safety system operates the vehicle in a manner that most closely reflects the intent of the operator, while preventing dangerous driving situations.

In one embodiment, a system is disclosed. The system includes a processor and a memory in communication with the processor. The memory stores a module including instructions that, when executed by the processor, cause the processor to receive, from an operator of a vehicle, an input intended to control the vehicle. The instructions also cause the processor to evaluate a safety of the input using a state-action function that quantifies the safety of the input based on a current state of the vehicle. The instructions also cause the processor to optimize, based on the safety, a vehicle action that modifies the input by minimizing a deviation between the input and the vehicle action. The instructions further cause the processor to execute, based on the safety, the vehicle action to control the vehicle, thereby maintaining safety while maximally preserving human agency.

In another embodiment, a non-transitory computer-readable medium is disclosed. The non-transitory computer-readable medium includes instructions that, when executed by a processor, cause the processor to receive, from an operator of a vehicle, an input intended to control the vehicle. The instructions also cause the processor to evaluate a safety of the input using a state-action function that quantifies the safety of the input based on a current state of the vehicle. The instructions also cause the processor to optimize, based on the safety, a vehicle action that modifies the input by minimizing a deviation between the input and the vehicle action. The instructions further cause the processor to execute, based on the safety, the vehicle action to control the vehicle, thereby maintaining safety while maximally preserving human agency.

In yet another embodiment, a method is disclosed. The method includes receiving, from an operator of a vehicle, an input intended to control the vehicle. The method also includes evaluating a safety of the input using a state-action function that quantifies the safety of the input based on a current state of the vehicle. The method also includes optimizing, based on the safety, a vehicle action that modifies the input by minimizing a deviation between the input and the vehicle action. The method further includes executing, based on the safety, the vehicle action to control the vehicle, thereby maintaining safety while maximally preserving human agency.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of a vehicle within which systems and methods disclosed herein may be implemented.

FIG. 2 illustrates one example of a safety system that is associated with a vehicle.

FIG. 3 illustrates one embodiment of the system of FIG. 2 in a cloud-computing environment.

FIG. 4 illustrates one example of a method for optimizing and executing a vehicle action that modifies an input of an operator of the vehicle to maintain safe operation of the vehicle while preserving the intent of the operator.

FIG. 5 illustrates an example of a vehicle on a racetrack including an unsafe path for the vehicle and a safe path.

FIG. 6 illustrates an example of displaying, within a vehicle, visual cues to depict to a driver of the vehicle a vehicle action relative to the intent of the operator.

### DETAILED DESCRIPTION

Systems and methods associated with a safety system are disclosed. As noted above, in some instances, automation surprise can lead to dangerous driving scenarios and uncomfortable driving experiences. Accordingly, the embodiments described herein are directed to the graduated intervention of a human-operated vehicle to ensure safety while maximally preserving the agency of the operator. In one approach, the safety system is configured to receive, from the operator, an input intended to control the vehicle. The input, in one implementation, is a position and/or movement of a steering wheel and/or a brake/accelerator pedal of the vehicle. In one approach, the safety system evaluates a safety of the input using a state-action safety value function that quantifies the safety of the input based on the current state of the vehicle. The current state of the vehicle, in one approach, includes the position of the vehicle with respect to an external environment of the vehicle, characteristics about the movement of the vehicle such as speed, acceleration, etc., contact between the wheels of the vehicle and the road on which the vehicle is traveling, etc. In one implementation, if the safety system determines that the safety of the input satisfies a safety constraint, the safety system will execute the input to operate the vehicle according to an original intent of the operator.

However, if the safety system determines that the safety of the input does not satisfy the safety constraint, the safety system will, in one embodiment, optimize and execute a vehicle action that modifies the input to maintain safe operation of the vehicle while preserving the intent (e.g., the original control input of the operator). In one approach, the vehicle action is a modification of the input of the operator that minimizes a deviation between the input and the vehicle action. In any case, the safety constraint is, in one embodiment, defined according to a model-free discrete-time control barrier function that ensures that the state-action safety value function of the vehicle action satisfies a threshold value derived from a current state safety value function. As a result, the safety system operates the vehicle in a manner that most closely reflects the intent of the operator, while preventing dangerous driving situations.

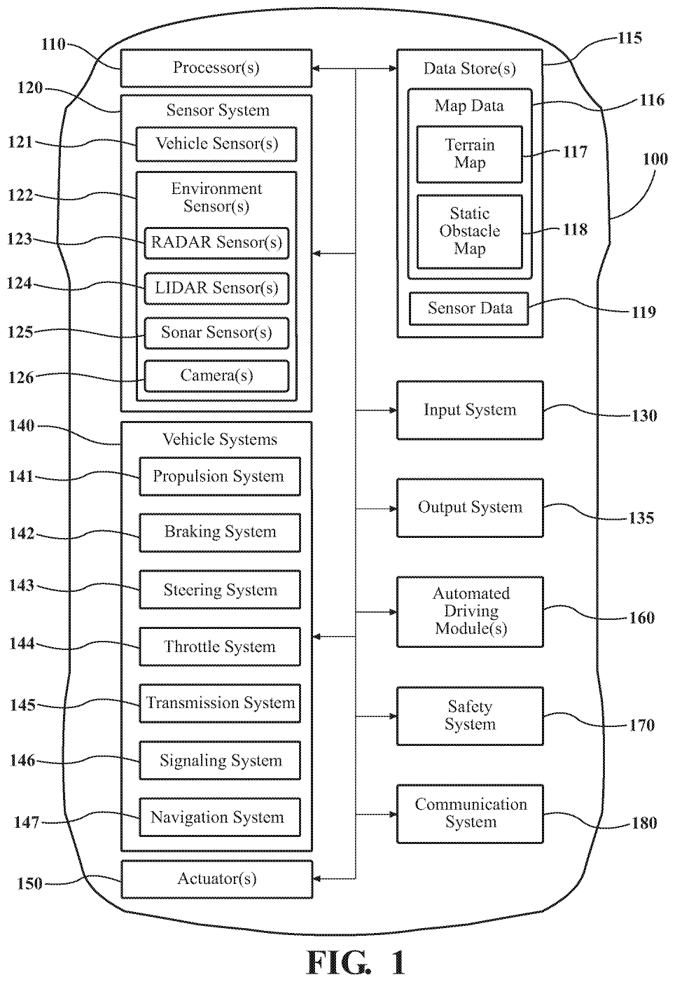

Referring now to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be another form of motorized transport such as a train, an aircraft, a bus, or a motorcycle. The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within the vehicle 100 while further components of the system are implemented within a cloud-computing environment or other system that is remote from the vehicle 100.

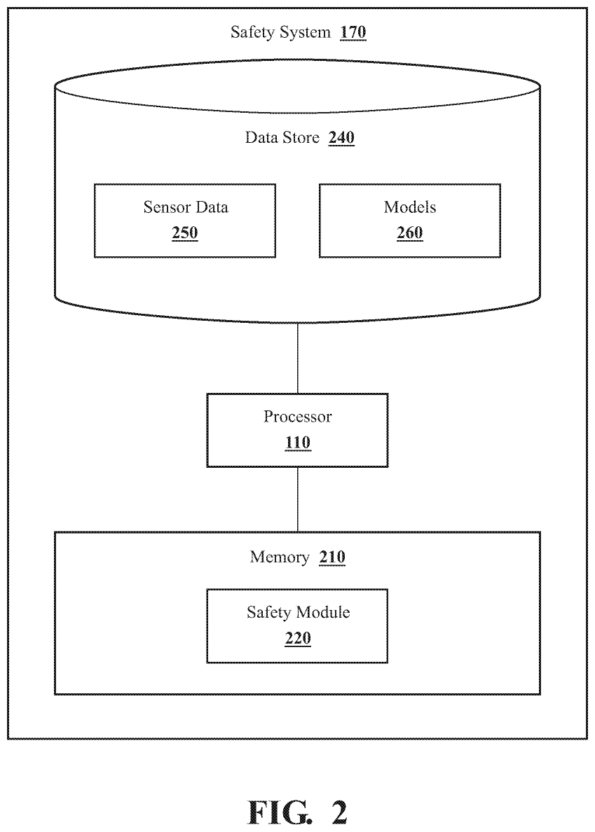

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In any case, the vehicle 100 includes a safety system 170 that is implemented to perform methods and other functions disclosed herein relating to maintaining the safe operation of the vehicle 100. As will be discussed in greater detail subsequently, the safety system 170, in various embodiments, is implemented partially within the vehicle 100 and as a cloud-based service. For example, in one approach, functionality associated with at least one module of the safety system 170 is implemented within the vehicle 100 while further functionality is implemented within a cloud-based computing system. Thus, the safety system 170 may include a local instance at the vehicle 100 and a remote instance that functions within the cloud-based environment.

Moreover, the safety system 170, as provided for within the vehicle 100, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a Wi-Fi, DSRC, V2I, V2V, or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 to communicate with various remote devices (e.g., a cloud-based server). In any case, the safety system 170 can leverage various wireless communication technologies to provide communications to other entities, such as members of the cloud-computing environment.

With reference now to FIG. 2, one embodiment of the safety system 170 of FIG. 1 is further illustrated. The safety system 170 is shown as including a processor 110 from the vehicle 100 of FIG. 1. Accordingly, the processor 110 may be a part of the safety system 170, the safety system 170 may include a separate processor from the processor 110 of the vehicle 100, or the safety system 170 may access the processor 110 through a data bus or another communication path. In one embodiment, the safety system 170 includes a memory 210 that stores a safety module 220. The memory 210 is a random-access memory (RAM), read-only memory (ROM), a hard-disk drive, a flash memory, or other suitable memory for storing the safety module 220. The safety module 220 includes, for example, computer-readable instructions that, when executed by the processor 110, cause the processor 110 to perform the various functions disclosed herein. In alternative arrangements, the safety module 220 includes independent elements from the memory 210 that are, for example, comprised of hardware elements. Thus, the safety module 220 alternatively includes ASICs, hardware-based controllers, a composition of logic gates, or another hardware-based solution.

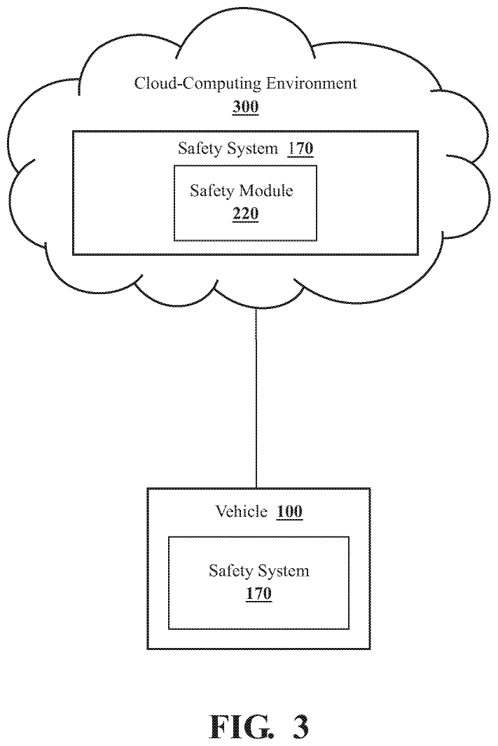

The safety system 170 as illustrated in FIG. 2 is generally an abstracted form of the safety system 170 as may be implemented between one or more vehicles and a cloud-computing environment. FIG. 3 illustrates one example of a cloud-computing environment 300 that may be implemented along with the safety system 170. As illustrated in FIG. 3, the safety system 170 is embodied at least in part within the cloud-computing environment 300.

Accordingly, as shown, the safety system 170 may include separate instances within one or more entities of the cloud-based environment 300, such as servers, and also instances within one or more remote devices (e.g., vehicles) that function to acquire, analyze, and distribute the noted information. In a further aspect, the entities that implement the safety system 170 within the cloud-based environment 300 may vary beyond transportation-related devices and encompass mobile devices (e.g., smartphones), and other devices that, for example, may be carried by an individual within a vehicle, and thereby can function in cooperation with the vehicle 100. Thus, the set of entities that function in coordination with the cloud environment 300 may be varied.

With continued reference to FIG. 2, in one embodiment, the safety system 170 includes a data store 240. The data store 240 is, in one embodiment, an electronic data structure stored in the memory 210 or another data store that is configured with routines that can be executed by the processor 110 for analyzing stored data, providing stored data, organizing stored data, and so on. Thus, in one embodiment, the data store 240 stores data used by the safety module 220 in executing various functions. In one approach, the data includes various types of data that the safety module 220 uses to maintain safe operation of the vehicle 100. Various types of data including sensor data 250 will be described in further detail below. In any case, the data store 240 includes data along with, for example, metadata that characterize various aspects of the data. For example, the metadata can include location coordinates (e.g., longitude and latitude), relative map coordinates or tile identifiers, time/date stamps from when the separate data was generated, and so on. In one embodiment, the data store 240 stores the data. In one embodiment, as described in further detail below, the data store 240 also includes one or more model(s) 260 that may be leveraged to process the data.

As mentioned above, in one embodiment, the data includes sensor data 250, including observations of one or more objects and/or people in an external environment of the vehicle 100 and/or perceptions from within a passenger compartment of the vehicle 100. The sensor data 250 may include various perceptions from sensors of a sensor system 120 of the vehicle 100. For example, the safety module 220 generally includes instructions that function to control the processor 110 to receive data inputs from one or more sensors of the vehicle 100. As provided for herein, the safety module 220, in one embodiment, acquires the sensor data 250 that includes at least perceptions of occupants within the vehicle 100. The safety module 220 may further acquire information from cameras 126 about surroundings of the vehicle 100. In further arrangements, the safety module 220 acquires the sensor data 250 from further sensors such as a radar 123, a LiDAR 124, and other sensors. Additionally, the safety module 220, when acquiring sensor data 250 from multiple sensors, fuses the sensor data 250 together to form the sensor data 250 and to provide for improved determinations of detection.

Accordingly, the safety module 220, in one embodiment, controls the respective sensors to provide the data inputs in the form of the sensor data 250. Additionally, while the safety module 220 is discussed as controlling the various sensors to provide the sensor data 250, in one or more embodiments, the safety module 220 can employ other techniques to acquire the sensor data 250 that are either active or passive. For example, the safety module 220 may passively sniff the sensor data 250 from a stream of electronic information provided by the various sensors to further components within the vehicle 100. Moreover, the safety module 220 can undertake various approaches to fuse data from multiple sensors when providing the sensor data 250. Thus, the sensor data 250, in one embodiment, represents a combination of perceptions acquired from multiple sensors and/or other sources. As part of controlling the sensors to acquire the sensor data 250, it is generally understood that the sensors acquire the sensor data 250 of a region around the vehicle 100 and/or a region within the vehicle 100 with data acquired from different types of sensors generally overlapping in order to provide for a comprehensive sampling of the external environment and/or internal environment of the vehicle 100 at each time step. In general, the sensor data 250 need not be of the exact same bounded region in the surrounding environment and/or the internal environment but should include a sufficient area of overlap such that distinct aspects of the areas can be correlated.

In one approach, the safety module 220 implements and/or otherwise uses a machine learning algorithm, which may be one or more of the model(s) 260. In one configuration, the machine learning algorithm is embedded within the safety module 220, such as a convolutional neural network (CNN), to perform various perceptions approaches over the sensor data 250 from which further information is derived. Of course, in further aspects, the safety module 220 may employ different machine learning algorithms or implement different approaches for performing the machine perception, which can include deep neural networks (DNNs), recurrent neural networks (RNNs), or another form of machine learning. Whichever particular approach the safety module 220 implements, the safety module 220 provides various outputs from the information represented in the sensor data 250. In this way, the safety system 170 is able to process the sensor data 250 into contextual representations.

As described herein, a machine learning algorithm includes but is not limited to deep neural networks (DNN), including transformer networks, convolutional neural networks, recurrent neural networks (RNN), etc., clustering algorithms, Hidden Markov Models, etc. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the safety system 170 generally trains the machine learning algorithm according to a particular training approach, which may include supervised training, self-supervised training, reinforcement learning, and so on. In contrast to training/learning of the machine learning algorithm, the safety system 170 implements the machine learning algorithm to perform inference. Thus, the general use of the machine learning algorithm is described as inference.

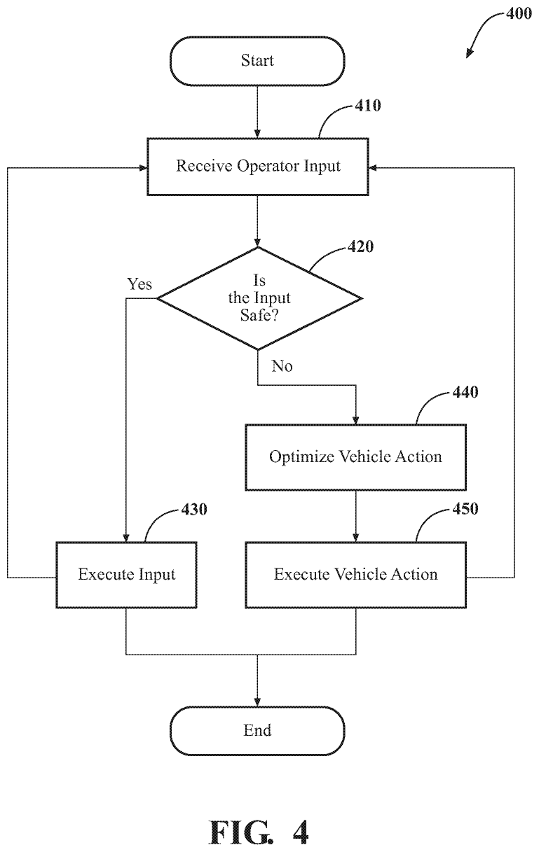

Additional aspects of the safety system 170 will be discussed in relation to FIG. 4. FIG. 4 illustrates a flowchart of a method 400 that is associated with maintaining the safe operation of the vehicle 100. Method 400 will be discussed from the perspective of the safety system 170 of FIGS. 1 and 2. While the method 400 is discussed in connection with the safety system 170, it should be appreciated that the method 400 is not limited to being implemented within the safety system 170 but that the safety system 170 is instead one example of a system that may implement the method 400.

At 410, in one approach, the safety module 220 receives an operator input. As described herein, an operator input is an input intended by the operator to control the vehicle 100 and includes the operation, by an operator of the vehicle 100 (e.g., a driver), of a steering wheel of the vehicle 100, a brake pedal of the vehicle 100, an accelerator pedal of the vehicle 100, and/or any other vehicular controls that may dictate the movement and/or operation of the vehicle 100. For example, the operator input can be the rotation of the steering wheel in combination with the depression of the accelerator pedal to control the vehicle 100 to turn while speeding up. In any case, the operator input can include sensor data 250 indicating the intent of the operator for controlling the vehicle 100. For example, the sensor data 250 can include data from a steering angle sensor, a torque sensor, pedal sensors, etc. In some embodiments, at 410, the safety module 220 acquires the operator input (which may include the sensor data 250) at successive iterations or time steps. Thus, the safety system 170, in one embodiment, iteratively executes the functions discussed at 410 to acquire data and provide information therefrom. Furthermore, the safety module 220, in one embodiment, executes one or more of the noted functions in parallel for separate observations in order to maintain updated perceptions.

With continued reference to FIG. 4, at 420, in one embodiment, the safety module 220 evaluates the operator input to determine if the input is safe. In one approach, evaluating the input includes processing data including the sensor data 250. Moreover, in one approach, the safety module 220 leverages one or more models 260 of the safety system 170 to evaluate the input and/or process the data. The model(s) 260 can include one or more of the models described above, for example, machine learning models, neural networks, etc.

In any case, as mentioned above, the safety module 220 evaluates a safety of the input (e.g., the safety module 220 determines if the input is safe or unsafe). As used herein, “safe” means that, if the input is executed, the input will cause the vehicle 100 to be operated in a manner that does not risk harm to the vehicle 100, an occupant of the vehicle 100, or others outside of the vehicle 100. Examples of “safe” operation of the vehicle 100 include instances in which the input will not cause the vehicle 100 to roll over, leave the boundary of the road upon which it is traveling, or be involved in a collision. Moreover, in one embodiment, the term “unsafe” refers to a condition in which the input would cause the vehicle 100 to approach the unsafe boundary too quickly. In any case, in one approach, the safety module 220 evaluates, at 420, the safety of the input using a state-action function that quantifies the safety of the input based on a current state of the vehicle 100. More specifically, in one approach, the safety module 220 ensures safe operation of the vehicle 100 according to the following framework, in which it is assumed that the vehicle 100 exhibits discrete-time nonlinear dynamics:

xₜ₊₁=ƒ(xₜ,uₜ) (1)
where xₜ∈X⊂ [symbol] ⁿ^{ₓ} and uₜ∈ [symbol] ⊂ [symbol] ⁿ^{ᵤ} denote the state and control input (e.g., the state of the vehicle 100 and the control of the operator of the vehicle 100) at time step t∈ [symbol] . The control of the vehicle 100, in one approach, comes from a task policy π^{task}:X→ [symbol] . The failure set [symbol] is defined, in one implementation, with a Lipschitz continuous safety margin function g:X→ [symbol] :

[symbol]

:={x∈X|g(x)<0}. (2)

States inside [symbol] are considered to have already failed in terms of safety, in one approach. In the context of racing, states that correspond to the race car being outside the track boundaries or in contact with another vehicle are, in some instances, inside [symbol] . The control set [symbol] and failure set [symbol] jointly define, in one instance, the vehicle's operational design domain (ODD). The ODD may be understood as a social contract that bridges the robot operator, the public, and policymakers—it provides a clear-cut set of conditions under which the vehicle 100 is required to operate safely. To ensure the safety of the vehicle 100 under the ODD, a supervisory control framework called a safety filter is implemented. The safety filter will be described in further detail below in connection with 440.

As mentioned above, to ensure the safety of the vehicle 100 under the ODD, a supervisory control framework called a safety filter is implemented. As used herein, a “safety filter” is an automated process that continuously monitors the operation of the vehicle 100 and intervenes, if deemed necessary, by modifying a candidate action given by the task policy π^{task} to prevent a potentially dangerous safety failure in the future. Specifically, instead of directly applying the task action uₜ=π^{task}(xₜ), the safety module 220 uses, in one approach, an action based on safety filtering:

uₜ=φ(xₜ,π^{task}) (3)

The specific function form of φ depends on the intervention type of a safety filter, which includes, e.g., switching, transition, and optimization. The safety filter prevents the use of a task action that would compromise future safety, allowing the safety module 220 to maintain the safety of the vehicle 100 without needing to modify its entire behavior. In one approach, a Hamilton-Jacobi (HJ) reachability analysis is used to synthesize the safety filter φ.

In one approach, the safety filter is designed such that, given ODD elements F and [symbol] , the safety module 220 operates the vehicle 100 within the maximal safe set [symbol] *⊂ [symbol] ^{c}⊂X, where [symbol] ^{c}=X− [symbol] . This set [symbol] * consists of, in one implementation, all states from which there exists a control policy that indefinitely prevents the vehicle 100 from entering [symbol] . In theory, [symbol] * can be computed using HJ reachability analysis, which employs level-set methods to recast the safety filter synthesis problem as an optimal control problem. Its solution follows from solving the dynamic programming safety Bellman equation:

V(x)=min{g(x), [symbol] V(ƒ(x,u))} (4)
which admits the safety value function V:X→ [symbol] as its fixed-point solution. Given V(⋅), the maximal safe set [symbol] * is then defined, in one approach, as:

[symbol]

*:={x∈X|V(x)≥0}⊂ [symbol] ^{c}. (5)

For subsequent extension to the safety filter, a Q-function is adopted to modify equation (4) into the state-action safety Bellman equation:

Q(x,u)=min{g(x), [symbol] Q(ƒ(x,u),u′)} (6)
which admits the state-action safety value function Q:X× [symbol] → [symbol] as its fixed-point solution. This formulation remains equivalent to equation (4) in the sense that V(x)= [symbol] Q(x,u).

A Last-Resort Safety Filter (LRSF) is then introduced, which is a value-based safety filter constructed upon the safety value functions Q(⋅,⋅) and V(⋅):

$$u ( x ) = \{ \begin{matrix}{π}^{task} ( x ) , \\ \text{?} ( x ) ,\end{matrix} \begin{matrix}{∀}_{x} ∈ 𝒳 \\ \end{matrix} \begin{matrix}s . t . V ( x ) > 0 \\ otherwise ,\end{matrix} \qquad ( 7 )$$

where the safe fallback policy is defined as [symbol] (x):=arg [symbol] Q(x,u), and π^{task}(⋅) is any task-oriented policy that does not explicitly account for safety. Equation (7) is referred to, in one instance, as a “last-resort” strategy since the safety filter, in one approach, does not intervene until V(x)=0: the critical point at which the vehicle 100 is about to exit [symbol] *. Upon reaching the boundary of [symbol] *, in one approach, LRSF fully overrides the control with [symbol] (⋅) to enforce safety.

In some instances, LRSF may have limitations. First, its task-agnostic fallback policy often leads to discontinuous and jerky interventions. This can become more pronounced in a shared autonomy setting, where human operators might feel surprised and confused by abrupt overrides. Even though LRSF offers maximum freedom until the system reaches the boundary of [symbol] *, its human-agnostic interventions risk diminishing the sense of control of the operator. Furthermore, the time and space complexities required to solve equation (4) scale exponentially with the state-space dimension, rendering grid-based dynamic programming infeasible for real-world safe control.

Accordingly, the safety filter described herein addresses these limitations by synthesizing an output that minimally deviates from the human input of the operator, thereby enhancing both agency and smoothness while still enforcing safety. Additionally, safety reinforcement learning (RL), which is described in further detail below, is leveraged to approximate the Q-function via RL, enabling the synthesis of a best-effort fallback policy [symbol] (⋅) for high-dimensional systems.

Another approach for value-based safety filtering is the implementation of the Discrete-time Control Barrier Function (DCBF):
Definition 1: A function h:X→ [symbol] is a DCBF for system (1) if [symbol] ={x∈X|h(x)≥0}= [symbol] ^{c} and ∃α∈(0,1] that satisfies:

[symbol]

Δh(x,u)≥−αh(x), ∀X∈X (8)
where Δh(x,u):=h(ƒ(x,u))−h(x).

Unlike LRSF, which imposes safety through hard overrides, a DCBF enables smooth safety interventions by solving an optimization problem that finds the safety-enforcing action closest to the task action u^{task}(x):

u(x)=arg [symbol] ∥u^{task}(x)−u²∥, (9a)

s.t. Δh(x,u)≥−∝h(x), (9b)
where equation (9b) is the DCBF constraint. The trade-off is that a DCBF no longer enforces safety within the maximal safe set [symbol] * in general. Instead, it encodes safety with respect to a (smaller) safe set [symbol] ={x∈X|h(x)≥0}⊆ [symbol] *.

An HJ safety value function V(⋅) is closely linked to a DCBF in the sense that, if V(⋅) is continuously differentiable, it automatically qualifies as a valid DCBF for the maximal safe set [symbol] *. This insight enables the use of V(⋅) in a smooth, DCBF-based safety filter rather than an LRSF alternative, an approach that underpins the present safety filter.
Remark 1: It should be noted that Definition 1 could be relaxed such that equation (8) is required to hold for all xₜ∈{x∈X|h(x)≥0}. A control input uₜ∈ [symbol] that satisfies equation (9b) for any function h(⋅) meeting the relaxed DCBF definition still renders the 0-superlevel set of h(⋅) forward invariant. Such relaxation of equation (8) still guarantees safety, but loses the set attractiveness property for the 0-superlevel set of h(⋅).

Building on the HJ reachability analysis and DCBFs, the safety filter framework is extended to a model-free setting. The safety value function V(⋅) is itself a valid DCBF in the sense of Definition 1. The state-action safety value function Q(⋅,⋅) is then adopted to introduce a model-free equivalence of the DCBF constraint. Leveraging these results, a human-centered safety filter (HCSF) is proposed, which solves an Optimal Control Problem (OCP) at every time step to “anchor” the filtered input near the human's actions (e.g., the input), while still ensuring safety via the model-free DCBF constraint. A Model-free DCBF formulation will now be described:
Proposition 1 (Model-free DCBF): The safety value function V(x):X→ [symbol] , which is a fixed-point solution of the safety Bellman equation (4), is a valid DCBF as defined in Definition 1 and Remark 1. The corresponding DCBF constraint is:

Q(x,u)≥γV(x), (10)
where γ∈[0,1). Following the notation from Definition 1, γ is equivalent to 1−∝.

A key difference should be noted between the original DCBF constraint (9b) and the present formulation (10)—the requirement (or lack thereof) of the system dynamics. Given Q(⋅,⋅) that satisfy equation (6), equation (10) does not require the system dynamics for its evaluation. This enables its application to safety-critical systems with black-box (e.g., unknown) dynamics. An example of such systems is a high-fidelity car racing simulator. On the contrary, evaluating the original DCBF constraint (9b) does require a priori knowledge of the dynamics of the system, which prohibits it from being applied to systems with unknown dynamics. It is also noted that equation (10) constrains the system such that V(⋅) cannot decay below 0. In other words, it keeps the system within the maximal safe set [symbol] *, in contrast to many handcrafted DCBFs that often suffer from conservative safe sets.

Proposition 1 is now leveraged to define the HCSF, a safety filter tailored for shared autonomy settings. The HCSF solves an OCP at each time step to synthesize a safe action that minimally deviates from the human control u^{human}(x) (e.g., the input) while satisfying the model-free DCBF constraint.
Definition 2. The HCSF is defined, in one approach, as follows:

u(x)=arg [symbol] ∥u^{human}(x)−u|², (11a)

s.t. Q(x,u)≥γV(x), (11b)

where γ∈[0,1) is a design parameter that dictates how quickly the safety value function is allowed to decrease over a single timestep. In one approach, γ is a threshold value that defines a constraint on the vehicle action within a maximal safe set when the threshold is satisfied, wherein the maximal safe set includes states of the vehicle in which a control policy that prevents the vehicle from entering an unsafe state exists.

It should be noted that, according to equation (11a), optimizing the vehicle action at 440 includes, in one approach, minimizing the squared difference between the input and the vehicle action. In other words, in one implementation, the vehicle action modifies the input by minimizing a deviation between the input and the vehicle action. As a result, the safety system 170 can maintain the safety of the vehicle 100 while maximally preserving human agency. According to the safety system 170 as described herein, in one approach, maintaining the safety of the vehicle 100 includes ensuring that the vehicle 100 does not enter an unsafe state, as defined above. Moreover, in one approach, maximally preserving human agency includes modifying the input with automated controls to generate shared control for operating the vehicle 100. Accordingly, by maintaining the safety of the vehicle 100 while maximally preserving human agency, the safety system 170 preserves the safety of the operator and a sense of control of the operator over the vehicle 100.

Moreover, it should be noted that equation (11b) is a safety constraint that is a model-free DCBF that ensures that the state-action function of the vehicle action satisfies a threshold value derived from a current state function (e.g., V(x)). The model-free DCBF constraint ensures that the safety value function does not decay below the specified threshold γV(x) at each time step. The recursive feasibility of the HCSF is a direct consequence of V(⋅) being a valid DCBF, as stated in Proposition 1. This is formalized in the following proposition:
Proposition 2 (Recursive Feasibility of HCSF): The optimization problem in equation (11) is recursively feasible for ∀γ∈[0,1), given any initial state x∈ [symbol] .

Following the above framework for safety, if the safety module 220 determines at 420 that the input is safe (e.g., if the safety module 220 determines at 420 that the safety constraint is satisfied), the safety module 220, in one approach, executes the input at 430. In one approach, satisfying the constraint means that the state-action function of the vehicle action is greater than or equal to a threshold value derived from a current state function. In some instances, the constraint is relative to the definition of the state-action function, the threshold value, and the current state function. Moreover, in one approach, executing the input at 430 means that the safety module 220 allows the vehicle 100 to be operated according to the parameters of the input. For example, if the input is the depression of the accelerator pedal by the operator, the vehicle 100 will accelerate.

On the other hand, if the safety module 220 determines at 420 that the input is not safe according to the above framework for safety, the safety module 220, in one approach, optimizes a vehicle action at 440. As used herein, the “vehicle action” may be one of (1) a modified version of the input that maintains the safety of the vehicle 100 or (2) a new control input generated by the safety module based on the input that maintains the safety of the vehicle 100. In either case, in one approach, the safety module 220 optimizes the vehicle action such that the vehicle action most closely matches the input of the operator while ensuring that the vehicle 100 is operated safely, thereby maintaining safety while maximally preserving human agency.

Referring back to Definition 2 and Proposition 2, these frameworks establish that the HCSF actively promotes human agency by selecting an action that remains as close as possible to the human's intended input, while ensuring the vehicle 100 never leaves the maximal safe set, thereby enabling the optimization of the vehicle action at 440.

Upon optimizing the vehicle action at 440 based on the safety evaluated at 420, the safety module 220, in one approach, executes the vehicle action at 450 to control the vehicle 100. Upon execution of either the input at 430 or the vehicle action at 450, in one approach, the method 400 returns to 410. As a result, the safety system 170 continually monitors the input at each time step to evaluate whether the input is safe and whether the safety system 170 should intervene. Accordingly, the safety system 170 preserves the safety of the operator at each time step, while maximally preserving the sense of control of the operator over the vehicle 100.

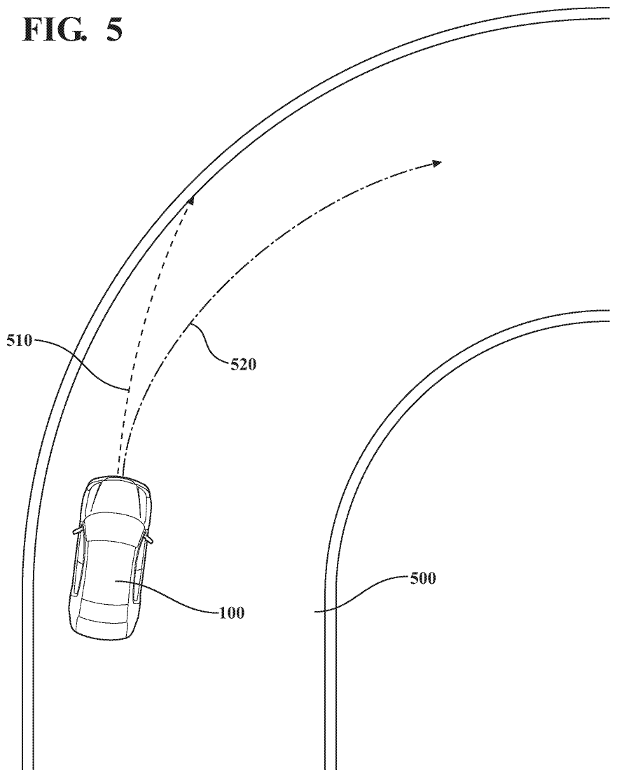

Referring now to FIG. 5, one example of the operation of the vehicle 100 according to the HCSF is shown. More specifically, FIG. 5 depicts an example of the vehicle 100 on a racetrack 500 in which an unsafe path 510 and a safe path 520 for the vehicle 100 are shown. In one instance, the unsafe path 510 is a path that the vehicle 100 may follow upon the execution of an operator input that is not subject to the HCSF, while the safe path 520 is a path that the vehicle 100 may follow upon the execution of an operator input that is subject to the HCSF. In the example shown, the operator input could be a steering wheel angle, a depression of the accelerator pedal, a depression of the brake pedal, or a combination of one or more of these inputs that will cause the vehicle 100 to cross the boundary of the racetrack 500. It can be seen that the operator input will cause the vehicle 100 to be unsafely operated since the vehicle 100 will cross the boundary of the racetrack 500. However, when the operator input is subject to the HCSF, the safety module 220 determines a vehicle action based on the operator input that produces the safe path 520, which is a path that very closely reflects the intention of the operator (e.g., driving closely to the boundary of the racetrack 500), but that is modified for safe operation of the vehicle 100. In other words, the operator input is modified according to the HCSF so that the vehicle 100 safely remains within the boundary of the racetrack 500 but following a trajectory that matches as closely as possible the input of the operator.

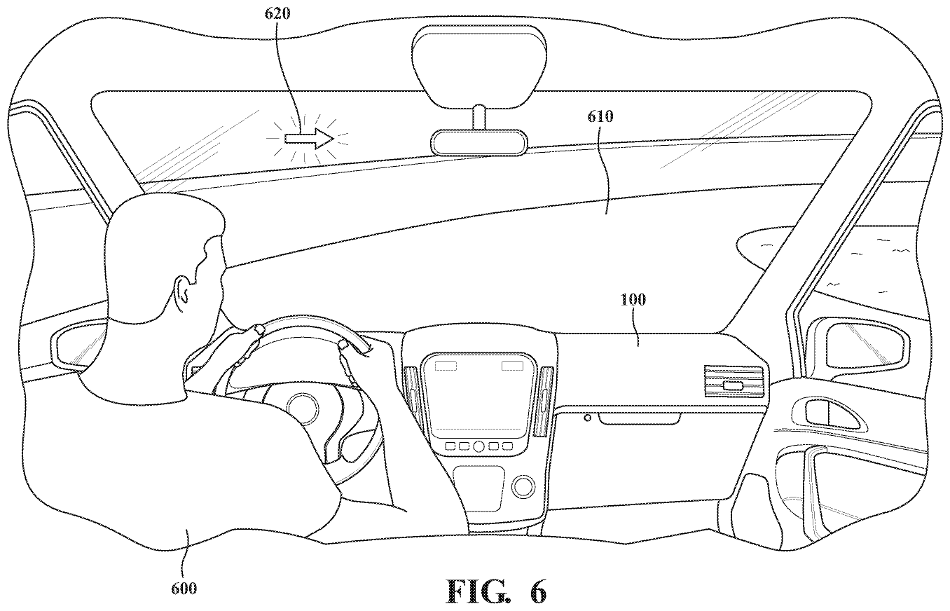

In some instances, it may be advantageous to provide an indication of the execution of the vehicle action to the operator to improve the understanding of the operator of the safety system 170. Accordingly, with reference now to FIG. 6, in one embodiment, the safety module 220 may be configured to display, within the vehicle 100, visual cues to depict to the operator various characteristics of the vehicle action relative to the input. As shown in FIG. 6, an operator 600 drives the vehicle 100 along a road 610. In the example shown, the safety module 220 may determine a vehicle action that steers the vehicle 100 to the right. Accordingly, the safety module 220 can display a visual cue 620 (e.g., a right arrow) to the operator 600 to indicate that the vehicle action is to steer the vehicle 100 to the right.

In some implementations, the visual cue 620 can depict a direction and a magnitude of the vehicle action relative to the input. For example, displaying the visual cue 620 as an arrow can depict the direction of the vehicle action, especially when the vehicle action includes turning the vehicle 100 to the left or the right. Moreover, regarding the magnitude, in some instances the magnitude of the vehicle action can be depicted via the size and/or brightness of the visual cue 620. For example, a brighter and/or larger visual cue 620 can depict a vehicle action with a greater difference relative to the input, while a dimmer and/or smaller visual cue 620 can depict a vehicle action that is more similar to the input.

As shown, the visual cue 620 is a digital arrow displayed on a heads-up display of a windshield of the vehicle 100. However, it should be understood that the visual cue may be displayed in other locations within the vehicle 100 and in other manners as well. For example, the visual cue 620 can be displayed on an instrument panel and/or a user interface of the vehicle 100, can be projected onto the windshield or another surface within the vehicle 100, or can even be displayed on a personal electronic device of the operator, for example, a mobile phone, a smart watch, etc.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as an advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 110. In one or more arrangements, the processor(s) 110 can be a primary/centralized processor of the vehicle 100 or may be representative of many distributed processing units. For instance, the processor(s) 110 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 100.

The vehicle 100 can include one or more data stores 115 for storing one or more types of data. The data store 115 can be comprised of volatile and/or non-volatile memory. Examples of memory that may form the data store 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drives (SSDs), and/or other non-transitory electronic storage medium. In one configuration, the data store 115 is a component of the processor(s) 110. The data store 115 is operatively connected to the processor(s) 110 for use thereby. The term “operatively connected,” as used throughout this description, can include direct or indirect connections, including connections without direct physical contact.

In one or more arrangements, the one or more data stores 115 include various data elements to support functions of the vehicle 100, such as semi-autonomous and/or autonomous functions. Thus, the data store 115 may store map data 116 and/or sensor data 119. The map data 116 includes, in at least one approach, maps of one or more geographic areas. In some instances, the map data 116 can include information about roads (e.g., lane and/or road maps), traffic control devices, road markings, structures, features, and/or landmarks in the one or more geographic areas. The map data 116 may be characterized, in at least one approach, as a high-definition (HD) map that provides information for autonomous and/or semi-autonomous functions.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. In one or more arrangements, the map data 116 includes one or more static obstacle maps 118. The static obstacle map(s) 118 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 119 is data provided from one or more sensors of the sensor system 120. The sensor data 119 may include observations of a surrounding environment of the vehicle 100 and/or information about the vehicle 100 itself. In some instances, one or more data stores 115 located onboard the vehicle 100 store at least a portion of the map data 116 and/or the sensor data 119. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 120 and/or the one or more sensors can be operatively connected to the processor(s) 110, the data store(s) 115, and/or another element of the vehicle 100.

Various examples of different types of sensors will be described herein. However, it will be understood that the embodiments are not limited to the particular sensors described. In various configurations, the sensor system 120 includes one or more vehicle sensors 121 and/or one or more environment sensors. The vehicle sensor(s) 121 function to sense information about the vehicle 100 itself. In one or more arrangements, the vehicle sensor(s) 121 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 120 can include one or more environment sensors 122 that sense a surrounding environment (e.g., external) of the vehicle 100 and/or, in at least one arrangement, an environment of a passenger cabin of the vehicle 100. For example, the one or more environment sensors 122 sense objects in the surrounding environment of the vehicle 100. Such obstacles may be stationary objects and/or dynamic objects. Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 includes one or more radar sensors 123, one or more LIDAR sensors 124, one or more sonar sensors 125 (e.g., ultrasonic sensors), and/or one or more cameras 126 (e.g., monocular, stereoscopic, RGB, infrared, etc.).

Continuing with the discussion of elements from FIG. 1, the vehicle 100 can include an input system 130. The input system 130 generally encompasses one or more devices that enable the acquisition of information by a machine from an outside source, such as an operator. The input system 130 can receive an input from a vehicle passenger (e.g., a driver/operator and/or a passenger). Additionally, in at least one configuration, the vehicle 100 includes an output system 135. The output system 135 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 140. Various examples of the one or more vehicle systems 140 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 141, a braking system 142, a steering system 143, a throttle system 144, a transmission system 145, a signaling system 146, and a navigation system 147.

The navigation system 147 can include one or more devices, applications, and/or combinations thereof to determine the geographic location of the vehicle 100 and/or to determine a travel route for the vehicle 100. The navigation system 147 can include one or more mapping applications to determine a travel route for the vehicle 100 according to, for example, the map data 116. The navigation system 147 may include or at least provide a connection to a global positioning system, a local positioning system or a geolocation system.

In one or more configurations, the vehicle systems 140 function cooperatively with other components of the vehicle 100. For example, the processor(s) 110, the safety system 170, and/or automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the navigation and/or maneuvering of the vehicle 100. The processor(s) 110, the safety system 170, and/or the automated driving module(s) 160 may control some or all of these vehicle systems 140.

For example, when operating in the autonomous mode, the processor(s) 110, the safety system 170, and/or the automated driving module(s) 160 control the heading and speed of the vehicle 100. The processor(s) 110, the safety system 170, and/or the automated driving module(s) 160 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, in one configuration, the vehicle 100 includes one or more actuators 150. The actuators 150 are, for example, elements operable to move and/or control a mechanism, such as one or more of the vehicle systems 140 or components thereof responsive to electronic signals or other inputs from the processor(s) 110 and/or the automated driving module(s) 160. The one or more actuators 150 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 110, implement one or more of the various functions described herein. In various arrangements, one or more of the modules are a component of the processor(s) 110, or one or more of the modules are executed on and/or distributed among other processing systems to which the processor(s) 110 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 160. The automated driving module(s) 160, in at least one approach, receive data from the sensor system 120 and/or other systems associated with the vehicle 100. In one or more arrangements, the automated driving module(s) 160 use such data to perceive a surrounding environment of the vehicle. The automated driving module(s) 160 determine a position of the vehicle 100 in the surrounding environment and map aspects of the surrounding environment. For example, the automated driving module(s) 160 determines the location of obstacles or other environmental features including traffic signs, trees, shrubs, neighboring vehicles, pedestrians, etc.

The automated driving module(s) 160 either independently or in combination with the safety system 170 can be configured to determine travel path(s), current autonomous driving maneuvers for the vehicle 100, future autonomous driving maneuvers and/or modifications to current autonomous driving maneuvers based on data acquired by the sensor system 120 and/or another source. In general, the automated driving module(s) 160 functions to, for example, implement different levels of automation, including advanced driving assistance (ADAS) functions, semi-autonomous functions, and fully autonomous functions, as previously described.

The arrangements disclosed herein provide the benefit of ensuring the safe operation of a vehicle while maximally preserving the agency of a human operator of the vehicle to control the vehicle. Moreover, the arrangements disclosed herein provide the benefit of informing the operator of a vehicle about an action taken by the vehicle in the event the input of the operator is evaluated to be unsafe.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, the arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some examples, “substantially” can include being within normal manufacturing tolerances.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory in communication with the processor and storing a module including instructions that, when executed by the processor, cause the processor to:
receive, from an operator of a vehicle, an input intended to control the vehicle;
evaluate a safety of the input using a state-action function that quantifies the safety of the input based on a current state of the vehicle;
optimize, based on the safety, a vehicle action that modifies the input by minimizing a deviation between the input and the vehicle action; and
execute, based on the safety, the vehicle action to control the vehicle, thereby maintaining safety while maximally preserving human agency.

2. The system of claim 1, wherein the instructions to optimize the vehicle action include instructions to minimize a squared difference between the input and the vehicle action.

3. The system of claim 1, wherein the instructions to evaluate the safety include instructions to evaluate the safety based on a safety constraint that is a model-free discrete-time control barrier function that ensures that the state-action function of the vehicle action satisfies a threshold value derived from a current state function.

4. The system of claim 3, wherein the module further includes instructions to, responsive to determining that the safety constraint is satisfied, execute the input.

5. The system of claim 3, wherein the threshold value defines a constraint on the vehicle action within a maximal safe set when the threshold value is satisfied, wherein the maximal safe set includes states of the vehicle in which a control policy that prevents the vehicle from entering an unsafe state exists.

6. The system of claim 1, wherein maintaining safety while maximally preserving human agency includes modifying the input that is provided by the operator with automated controls to generate shared control for operating the vehicle thereby preserving a sense of control of the operator over the vehicle.

7. The system of claim 1, wherein the module further includes instructions to display, within the vehicle, visual cues to depict to a driver of the vehicle a direction and a magnitude of the vehicle action relative to the input.

8. A non-transitory computer-readable medium including instructions that, when executed by a processor, cause the processor to:
receive, from an operator of a vehicle, an input intended to control the vehicle;
evaluate a safety of the input using a state-action function that quantifies the safety of the input based on a current state of the vehicle;
optimize, based on the safety, a vehicle action that modifies the input by minimizing a deviation between the input and the vehicle action; and
execute, based on the safety, the vehicle action to control the vehicle, thereby maintaining safety while maximally preserving human agency.

9. The non-transitory computer-readable medium of claim 8, wherein the instructions to optimize the vehicle action include instructions to minimize a squared difference between the input and the vehicle action.

10. The non-transitory computer-readable medium of claim 8, wherein the instructions to evaluate the safety include instructions to evaluate the safety based on a safety constraint that is a model-free discrete-time control barrier function that ensures that the state-action function of the vehicle action satisfies a threshold value derived from a current state function.

11. The non-transitory computer-readable medium of claim 10, wherein the instructions further include instructions to, responsive to determining that the safety constraint is satisfied, execute the input.

12. The non-transitory computer-readable medium of claim 10, wherein the threshold value defines a constraint on the vehicle action within a maximal safe set when the threshold value is satisfied, wherein the maximal safe set includes states of the vehicle in which a control policy that prevents the vehicle from entering an unsafe state exists.

13. The non-transitory computer-readable medium of claim 8, wherein maintaining safety while maximally preserving human agency includes modifying the input that is provided by the operator with automated controls to generate shared control for operating the vehicle thereby preserving a sense of control of the operator over the vehicle.

14. A method, comprising:
receiving, from an operator of a vehicle, an input intended to control the vehicle;
evaluating a safety of the input using a state-action function that quantifies the safety of the input based on a current state of the vehicle;
optimizing, based on the safety, a vehicle action that modifies the input by minimizing a deviation between the input and the vehicle action; and
executing, based on the safety, the vehicle action to control the vehicle, thereby maintaining safety while maximally preserving human agency.

15. The method of claim 14, wherein optimizing the vehicle action includes minimizing a squared difference between the input and the vehicle action.

16. The method of claim 14, wherein evaluating the safety includes evaluating the safety based on a safety constraint that is a model-free discrete-time control barrier function that ensures that the state-action function of the vehicle action satisfies a threshold value derived from a current state function.

17. The method of claim 16, further comprising, responsive to determining that the safety constraint is satisfied, executing the input.

18. The method of claim 17, wherein the threshold value defines a constraint on the vehicle action within a maximal safe set when the threshold value is satisfied, wherein the maximal safe set includes states of the vehicle in which a control policy that prevents the vehicle from entering an unsafe state exists.

19. The method of claim 14, wherein maintaining safety while maximally preserving human agency includes modifying the input that is provided by the operator with automated controls to generate shared control for operating the vehicle thereby preserving a sense of control of the operator over the vehicle.

20. The method of claim 14, further comprising displaying, within the vehicle, visual cues to depict to a driver of the vehicle a direction and a magnitude of the vehicle action relative to the input.
